(19) United States
(12) Patent Application Publication
(10) Pub. No.: US 2003/0071446 A1
(43) Pub. Date: Apr. 17, 2003

(54) Method of emergency actuation of movable surfaces on vehicles

(76) Inventors: Guenter Haderer, Buehl (DE); Stefan Rychlak, Ilsede (DE)

Correspondence Address: STRIKER, STRIKER & STENBY, 103 East Neck Road, Huntington, NY, 11743, US

(21) Appl. No.: 10/256,478

(22) Filed: Sep. 27, 2002

(30) Foreign Application Priority Data
Sep. 29, 2001 (DE) 101 48 340.6

(51) Int. Cl. B60R 21/00; B60R 21/32

(52) U.S. Cl. 280/735; 180/271; 180/268

(57) ABSTRACT

A method of activating surfaces which limit an inner space of a motor vehicle and are movable by adjusting drives, during occurrence of an accident event, includes the steps of providing the vehicle with occupant protection systems, releasing the occupant protection systems by a central control device, supplying to the central control device input signals of sensors which detect outer influences, inner influences or both, and moving the surfaces which limit the inner space by the central control device through in dependence on an accident event, to their opening position.

### BACKGROUND OF THE INVENTION

The present invention relates to method of emergency actuation of movable surfaces on vehicles.

In motor vehicles nowadays for actuation of window panes or doors as well as sliding/raising roofs electrical adjusting drives are used in increasing numbers. The electrical adjusting drives are supplied from the power system of the vehicle and are individually actuated by occupants. In the case of an accident for example the window panes on the one hand provide, however limited, protection for the vehicle occupants, since objects are not penetrated into the inner space and can not exit from it. On the other hand, in the case of an accident the window panes which remain closed prevent make difficult escape of occupants of crushed vehicles and makes difficult providing assistance from outside. The proposal for example of rising, not bursting window panes in the case of an accident can cause additional injury danger by splitting panes.

The European patent document EP 0 759 496 B1 discloses an electric window opener. In accordance with the solution disclosed in this document the electrical window opener is provided with a drive motor connected to an energy source. Its driven shaft is coupled with a guide, in which the window is supported. Between the driven shaft and the guide, a mechanical coupling disconnectable by hand or foot is provided. A freely rotatable cable drum is rotatably supported. Furthermore, the cable drum is coupled with the driven shaft, on which a cable guided in the guide is partially wound. The cable drum which is freely rotatable around a rotatably supported shaft is forced by a coupling spring into a coupling engagement with a drilling shaft, and sometimes with interposition of a transmission. A coupling disk is arranged on the shaft which is coupled the a driven shaft. It is non rotatable, but axially displaceable with the shaft and is loaded with a coupling spring. The coupling is disengageable by a lever which is engaged with the coupling disk and is actuatable by hand or foot.

With displacement of the coupling disk against the coupling spring, the closed window in emergency opens due to its weight, and the opening movement of the closed window can be accelerated by the occupant of the vehicle due to vertical pressure on the window. Thereby each occupant can leave the vehicle through an open side window.

With modern systems for increasing the passive safety of the occupants of motor vehicle, the corresponding traveling situation of the motor vehicles is monitored by a plurality of sensors. In the case of an emergency a central control system provided in the motor vehicle can interrupt the power supply to the internal combustion engine, or in other words to turn off the fuel supply pump. Furthermore, the control device can automatically turn on the warning blinking device, and in motor vehicles provided with navigation systems a transmission of the accident position of the motor vehicle is possible. In the case of an accident, depending on the gravity of the accident, or in other words the occurring accelerations, through the central control device also the release of a driver or a co-driver airbag as well as available side airbags is provided. Modern control devices in the motor vehicles can include sensors which pick up the occurring relative speeds or acceleration values, from which first the gravity and type of the occurring accident is detected, before corresponding control signals are activated for release of safety systems, for example the airbag. The activation itself of airbag or side airbag is performed then by the evaluation routine of the sensors of the central control device.

In the course of improvement of the passive safety of the vehicle occupants, intelligent safety belt systems are provided. In the case of an accident the tension of the safety belt which secure the occupants increases and subsequently a release or a relaxation of the safety belts is performed, to lower further the injury risk of the vehicle occupants.

### SUMMARY OF THE INVENTION

Accordingly, it is an object of the present invention to provide method of emergency actuation of movable surfaces on vehicles which avoids the disadvantages of the prior art.

More particularly, it is an object of the present invention to provide a method for in motor vehicles which are equipped with airbag systems for protection of vehicle occupants, such that its sensors with respect to occurring acceleration forces and/or relative speeds can be used for controlling electrical adjusting drives of movable surfaces or sliding roofs/rising roofs.

The sensor system provided in the motor vehicle and cooperating with a central airbag control device can contain peripheral front sensors so-called “pre-crash sensors, distance sensors for recognizing obstacles, and moisture sensors for determining the water level in the vehicle inner space, as well as an evaluating routine connected with release staged, in which the gravity and type of the accident is analyzed, and depending on the gravity of the accident, suitable release measures are introduced. The evaluating routine can distinguish between different categories of accidents, such as frontal and side impact, overturn, skidding or plunge in water. The sensor systems can be expanded functionally so that the recovered data for a traveling situation of a motor vehicle with respect to the occurrence of impermissible high acceleration values are processed with the further sensor signals in the evaluating routine, and for each purpose a few milliseconds are required. In the event of correspondingly determined gravity and category of the accident, the roof and window surfaces within a time period of between 30 and 100 ms are moved to their open position, in condition before the impact itself, and thereby injuries by splintering of the broken windows can be prevented.

Alternatively to an emergency opening by a central control device, the surfaces can be moved also by the control devices of the individual adjusting drive to their open position. The sensors can be integrated at least partially into the electronic system of the control device. For example, a moisture sensor can be formed so that a part of the printed circuit board is not coated with lacquer and thereby during dipping in water a water level signal is released.

In order to guarantee the reliability of the voltage supply of the adjusting drive, they can be joined both through the central electrical system and also through emergency voltage sources, which in the event of the failure of the electrical system of a motor vehicle guarantee a current supply to the electric adjusting drives.

Another possibility to allow access to the interior space or escape from it, is to arrange propellent charges between window frames and movable vehicle surfaces, such as a window pane, or a rising/sliding roof. A jumping out of a coupling element or a component which guides the movement of the movable surface, the movement of the window pane or the rising/sliding roof is facilitated, both at the inner as well as the outer side of the vehicle.

The propellent charge can be a chemical substance which can be accommodated on the one hand in a space economical manner and on the other hand can release a controlled gas quantity during its actuation. For igniting the propellent charge an ignition bus can be used, which also initiates the release of safety belts and the air bag. The propellent charge can be arranged between the movable surface and the drive, so that the window pane is separated inside the door hollow frame which encapsulates the electrical drive from it and can be released from it, from inside or from outside by hand or by ignition of a further propellent charge.

Depending on the gravity of the occurring accident results, determined by the sensor system due to the measured acceleration or relative movement values, in the evaluation routine the movement of the side windows in the doors of the motor vehicle, either by the adjusting drive or by ignition of a propellent charge can be delayed so that the side panes operate for a short time period of for example 10-20 ms as a support for the side airbags, so long until they are completely unfolded and provide an efficient protection of the occupants of the vehicle. When a submergence in water is determined, the surfaces and the belt locks advantageously can be open after an impact, so that the occupants of the vehicle can leave it simply underwater, in some cases can be slightly secured, since an opening of the door against the water pressure is practically impossible.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a sensor system for releasing safety belts and airbag systems and surfaces movable for emergency opening inside a vehicle;

FIG. 2 is a view illustrating an implementation possibility for an activation of the emergency actuation of wall surfaces in a motor vehicle; and

FIG. 3 is a further embodiment of an activation of the emergency actuation of movable surfaces in a motor vehicle.

### DESCRIPTION OF THE PREFERRED EMBODIMENTS

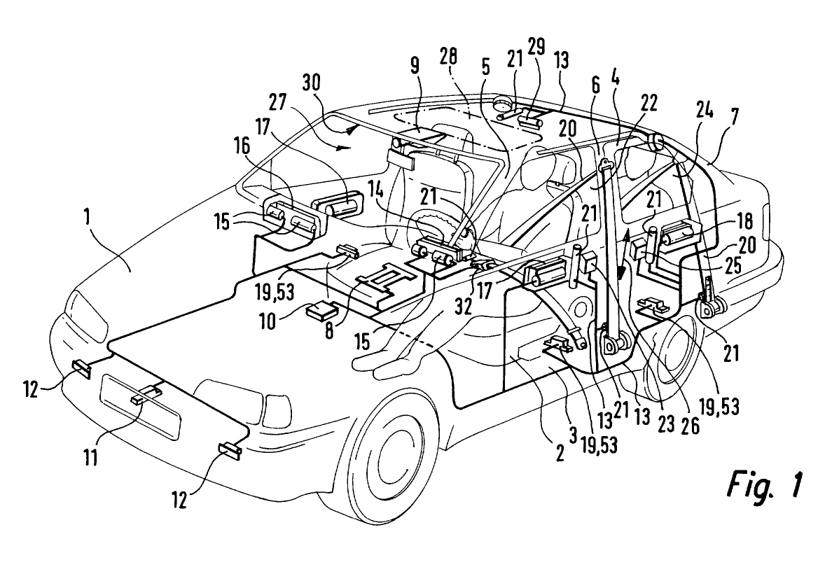

FIG. 1 shows a sensor system for release of safety belts and airbag systems, which can be arranged in an inner space of a vehicle.

An inner space 2 of a vehicle 1, in particular a motor vehicle, is substantially limited by the lateral surfaces of two front doors 3 as well as in some cases two rear doors 4. Furthermore, the inner space 2 is limited by a roof lining 30 in which a movable surface with the design of a combined raising/sliding roof 28 can be accommodated. Each of the front doors 3 is provided with a liftable and lowerable window pane 22, while each of the rear doors 4 includes also liftable and lowerable (compare reference numerals 26) window panes 24. Furthermore, the inner space 2 of the vehicle is limited by a windshield pane 27 as well as a not shown rear pane. The roof lining 30 is supported substantially by two A-supports 5 which are arranged parallel to one another, two B-supports 6 which are arranged parallel to one another, and two C-supports, to provide a sufficient rigidity to the vehicle occupant space of the vehicle 1.

A position module 9 can be integrated in the roof lining of the roof of the interior space 2. In cooperation with a navigation system it can transmit the exact vehicle position when an accident occurs. Furthermore, a weight sensor 8 is received in the inner space 2 of the vehicle 1, preferably in the bottom region. It transmits the actual weight of the vehicle 1, including the occupants, to a central control device 10.

The vehicle in accordance with the embodiment shown in FIG. 1 is provided with an occupant protection system for increasing the passive safety of the vehicle occupants. The weight sensor 8 in the bottom of the inner space 2 of the vehicle 1 is in communication with the central airbag control device 10. For this purpose, an activation bus 13 is provided, which in addition to bidirectional data conductors also contains a control bus or in other words an ignition bus for propellent charges. In a front region of the vehicle 1, a substantially centrally received front sensor 11 is provided, while in the region of the front fender on each side of the vehicle 1 pre-crush sensors 12 are arranged at a distance from one another. The front sensor 11 as well as the pre-crush sensors 12 are connected also through the activation bus 13 with the central control device 10 as well as with gas generators 15 for the airbag systems 14, 16, 17 and 18 which represent a first occupant protection system. In addition, acceleration sensors 19 and moisture sensors 53 are introduced in the system for increasing the passive safety of the vehicle occupants in the interior space of the vehicle 1.

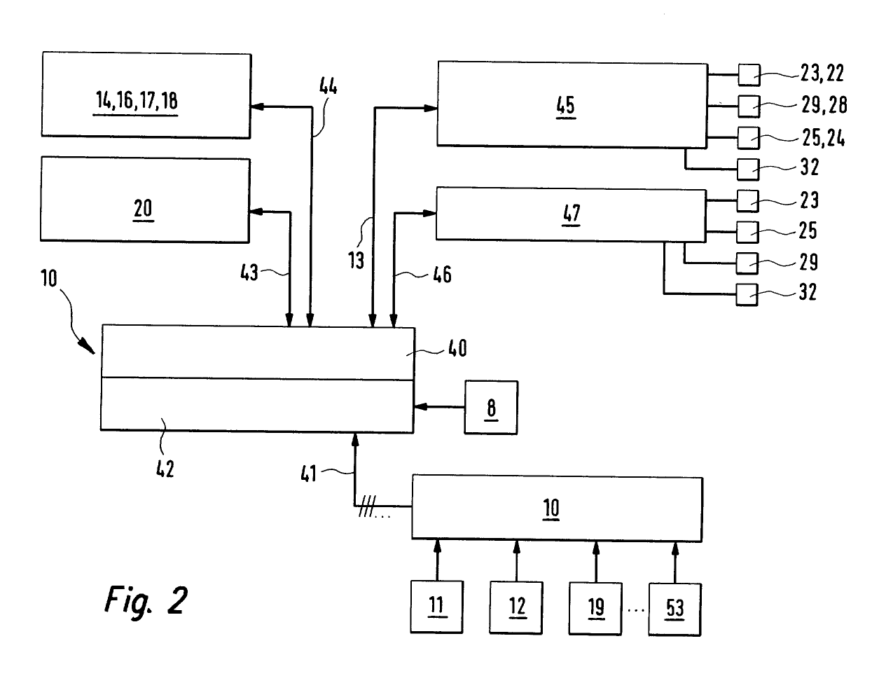

In addition to the determination of high acceleration values in a transverse direction as well as in a longitudinal direction by means of the sensors 8 and 19, also vehicle turning and rotary speed changes of the vehicle are detected and determined. The signals determined by the sensors 8, 11, 12, 19, 53 are transmitted to a further processing on the central control device 10. The central control device 10 can include a microcontroller 40, as well as evaluation routine 42 connected to it, as shown in FIG. 2. In the evaluation routine 40 from the input signals of the sensors 8, 11, 12, 19 and 53 the gravity and the nature of an occurring accident result are determined.

Depending on gravity and category determined from values transmitted by the sensors with respect to transverse accelerations or longitudinal accelerations or rotary speed rates or weight or water level in the inner space, via the bus system 13, 43, 44, 46 the occupant protection system is released.

In addition to the first occupant protection system formed by the airbags 14, 16, 17 and 18, the vehicle 1 is provided with a second occupant protection system which is formed by one safety belt of the safety belts 20 which secure the occupants with an automatic belt lock 22. The safety belts 20 which secure the occupants of the vehicle 1 in their seats, are associated in the lower region of the vehicle inner space with the activation bus 13 which can include an ignition bus, and with propellent charges 21 of a chemical propellent substance which releases a controlled gas quantity. When an accident event occurs, the propellent charges 21 which are associated with the safety belts 20 are ignited through pulses initiated by the central control device 10, depending on the input signals of the sensors 11, 12, so that a short tightening of the safety belts 20 is provided, which can be concluded after determinable time interval in a relaxation of the tightening of the safety belts 20 to avoid an injury risk, in particular bone breaking of the occupants of the vehicle.

In addition to the above mentioned first occupant protection system formed by the airbags 14, 16, 17 and 18 and the second occupant protection system represented by the tightening of the safety belts 20, a third occupant protection system can be implemented with respect to the surfaces limiting the inner space 2 of the vehicle 1, such as window panes 22 or 24, as well as in some cases a raising/sliding roof 28 formed in the roof lining. The movable surfaces 22, 24, 28 formed as pane material are as a rule actuated by the adjusting drives 23, 25, 29. These adjusting drives 23, 25, 29 as a rule are supplied with power through an electrical system of the motor vehicle, either of conventional 12V network or the prospective 42 V network. In addition to the central voltage supply through the electrical system of the vehicle, also individual adjusting drives 23, 25, 29 of the movable surfaces 22, 24, 28, similarly to the belt locks 32, can be associated with their own emergency voltage power sources, to increase their redundancy and to guarantee that during occurrence of an accident event if the electrical system of the vehicle fails, an opening of the movable surfaces 22, 24, 28 of the vehicle 1 is guaranteed.

The adjusting drives 23, 25, 28 can provide lifting and lowering of the window panes 22, 24 in a vertical direction 26, while the electrical adjusting drive 29 can provide a substantially horizontal movement of the raising/sliding roof.

When an accident event occurs, the adjusting drives 23, 25, 29 depending on the gravity of the occurring accident event, depending on data determined by the sensors 8, 11, 12, 19, 53, in some cases with a delay, are moved to their open position. The window panes 22, 24 or the raising/sliding roof 28 which limit the inner space 2 of the vehicle 1 move to their corresponding open position, so that both an escape of vehicle occupants which are not injured from the inner space 2 of the vehicle 1 is possible, and also the inner space 2 of the vehicle 1 is accessible from outside. In particular for vehicles with raising/sliding roofs 28, an accessibility of the inner space 2 in form of a large opening is provided, which completely excludes the risk of further injuries of the occupants of a crushed vehicle by splintering glass panes for providing the access to the inner space. In addition, with the third occupant protection system, in the event of an accident the belt locks 32 are open for example electromagnetically, so that the occupant after an accident in the vehicle, in particular under water, can easily escape. The moisture sensor 53 for detection of penetrating water is integrated in the printed circuit board of a control device 10′ which controls the belt locks 32 or alternatively can be formed as a float in a foot region of the inner space 2.

The third occupant protection system provided by the movement of the movable surfaces 22, 24, 28 can also include further propellent charge sets 21 which are controllable from the central control device 10, depending on gravity and category of the occurring accident, the activation bus 13. In this case, propellent charges 21 are associated with the adjusting drives 23, 25, 29 for the movable surfaces 22, 24, 28 which limit the inner space 2 of the vehicle 1. The electrical adjusting drives 23, 25, arranged in the inner spaces of front doors 3, or rear doors 4 transmit their adjusting movement through toothed gear elements or bowden cables to the window panes 22, 24 which are movable in the vertical direction 26 or in a horizontal direction in the case of the raising/sliding roof 28, and to the drive 29 which activates the same. When the electric drives 23, 25, 29 are associated with propellent charges 21, one of the transmission elements of the drive can burst open of the drive train, whereby a blocking of the movable surfaces 22, 24, 28, is released and they can be easily open both from inside and from outside. It is however also possible that the propellent charges 21 are arranged between a holder of the surfaces 22, 24, 28 and their frames so that by the ignition of the activation bus 13 the movable surfaces 22, 24, 28 can be directly moved to the open position.

In a variation of the embodiment, first one of the transmission elements of the drive jumps out of the drive train with its propellent charge 21 and subsequently the movable surfaces 22, 24, 28 are moved by a further propellent charge 21 directly to their opening position. As propellent charge sets 21 compactly structured chemical substances can be utilized, which release a controlled gas volume.

In accordance with a further embodiment of the third occupant protection system which is represented by surfaces 22, 24, 28 movable to their open position, the propellent charge sets can be arranged also between the adjusting drives 23, 25, 29 and the movable surfaces 22, 24, 28. During activation the connection between the adjusting drives 23, 25, 29 and the movable surfaces 22, 24, 28 can be completely separated. In the case of the front doors 3 or the rear doors 4, the propellent charge sets 21 can be directly arranged in the door hollow spaces associated with the adjusting drives 23, 25.

Also, the belt locks 32 can be burst open alternatively for electromagnet actuation by a propellent charges 21 which are activated from the central control device 10 through corresponding propellent charge ignitors 45.

FIG. 2 shows an implementation possibility of an activation of the emergency actuation of the movable surfaces in motor vehicles. As can be seen from FIG. 2, the central control device 10 for release of occupant protection systems for improving the passive safety of the vehicle occupants is supplied with input signals of sensors 8, 11, 12, 19, 53, to name only a few of them. The arrangement of the sensors 8, 11, 12, 19, 53 can be seen in FIG. 1. The input signals of the sensors 11, 12, 19 and 53 supplied to the central airbag control device 10 can be supplied either as input signals 41 of an evaluation routine 42 which is connected with a microcontroller 40, wherein the evaluation routine 42 can be integrated in the central airbag control system 10 as well as the microprocessor 40. In the evaluation routine 42, depending on the input signals 41 of the sensors 11, 12, 19, 53 the obtained retardation or acceleration data as well as informations of vehicle weight transmitted by the weight sensor 8 are processed. Depending on the input data of the weight sensor 8 or the input signals 41, the gravity and the category of the occurring accident event are judged and depending on exceeding of certain critical values, the above mentioned occupant protection system is activated through the microcontroller 40 or the central airbag control device 10.

The activation of the first occupant protection system, the second occupant protection system as well as the third occupant protection system can be performed either simultaneously or depending on the determined gravity of the occurring accident event in a stepped sequence. In the case of occurrence of small speeds, not always the release of the first occupant protection system designed as the airbags 14, 16, 17, 18 is required. It suffices to activate the second occupant protection system 20 by activation of the belt tensioning via a corresponding release signal 43. Depending on an optionally provided evaluation routine 42, the microcontroller 40 or the central airbag control device can activate through a corresponding release signal 43 the second occupant protection system 20 by tightening of the safety belts. The activation of the airbags 14, 16, 17, 18, by the control signals 44 through the microcontroller 40 can be performed also directly by the signals of the sensors 11, 12, arranged in the front region of the vehicle. In addition, a control of the first occupant protection system designed as the airbags 14, 16, 17, 18, is possible by control signals 44 generated by the microcontroller 40. The microcontroller 40 also can generate control signals 46 which can be applied to a control 47. By means of the control 47, an activation of the adjusting drives 23, 25, 29 of the corresponding mobile surfaces 22, 24, 28 which limit the inner space 2 of the vehicle is possible and of the belt locks 32. The adjusting drives 23, 25, 29 move the movable surfaces to their open position. They can be supplied with power through the intact electrical system of the vehicle or, similarly to the control 47 of the belt locks 32, can be supplied through redundant emergency power sources separately associated with the adjusting drives 23, 25, 29.

Alternatively to the control of the electric drives 23, 25, 29, through the control signals 46, the propellent charge sets 21 can be ignited by a propellent charge set ignitor 45, whose ignition pulse is transmitted through the activating or ignition bus 13. With the activation of the propellent charge sets 21 on the adjusting drives 23, 25, 29, individual components of the drive train between the movable surfaces 22, 24, 28 and the electrical adjusting drives 23, 25, 29 can jump out, so that a manual movement of the movable surfaces 22, 24, 28 is provided by lifting the self locking. The propellent charge sets 21 can be received in the inner space of the front doors 3 or the rear doors 4 under surfaces 22, 24, 28 movable in the vertical direction 26, so that in addition to the jumping out of the individual transmission components from the drive train, a complete separation of the movable surfaces 22, 24, 28 from the electrical drives 23, 25, 29 which act on them is possible. This is true both for the surfaces of the raising/sliding roof 28 movable in the roof lining 30, which can be moved by the electrical drive 29 and also for the electrical adjusting drives 23, arranged in the hollow spaces in the front doors 3 or the rear doors 4. After the separation of the drive train the adjusting drives 23, 25, 29 can move in a second stage the movable surfaces directly by further propellent charges 21 to their open position.

The time delay between the first ignition for the drive strand (or release of the adjusting drives 23, 25, 29) and the second ignition for movement of the surfaces 22, 24, 28 is controlled by the control device 10. The above mentioned adjusting drives 23, 25, 29 and the propellent charges 21 are all integrated in the activation or ignition bus 14 and are activatable by it. In the same way as during emergency opening operation of the surfaces 22, 24, 28, the belt locks 32 are associated with the propellent charges 21 which are ignited by the propellent charge ignitor 45 controlled through the ignition bus 13. Depending on gravity and category of the accident, the belt locks are burst open through the ignition bus 13 or are open through the control 47 automatically, for example electromagnetically.

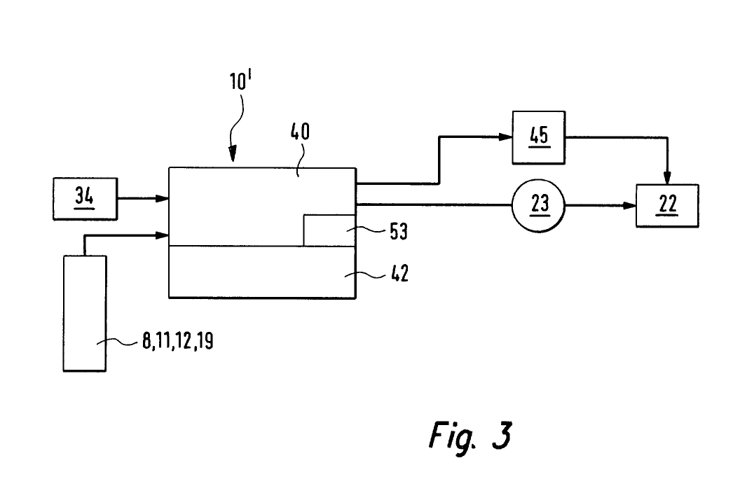

In accordance with a further embodiment shown in FIG. 3, the surfaces 22, 24, 28 and the belt lock 32 are not controlled by a central control device 10, but instead each individual movable surface 22, 24, 28 or the belt lock 32 is associated with its own separate control device 10′. The control device 10′ of the window pane 22 in FIG. 3 receives on the one hand input signals through a window operating unit 34 and on the other hand sensor signals 8, 11, 12, 19, 53 which detect the occurrence of an accident event. At least a part of the sensors is arranged in immediate vicinity to the control device 10′ or is integrated in it. For example the moisture sensor 53 is formed as a not lacquer-coated region on a printed circuit board of the control device 10′. The evaluating routine 42 for the categorizing of an accident is integrated also locally in each individual control device. For emergency opening of the pane 22, it is open by the adjusting drive 23 or alternatively through the propellent charges 21 activated by the propellent charge ignitor 45. The emergency opening operations of the various surfaces 22, 24, 28 and the belt locks 32 are completely independent from one another and can have an individual sensor system. The emergency opening of the belt locks 32 after an accident can be realized for example also without emergency opening of the movable surfaces 22, 24, 28.

In special cases it can be desired to close the movable surfaces, in particular a sliding roof directly before occurrence of an accident event in a very short time, for example for preventing throwing of occupants or penetration of objects, or increasing the stability of the occupant space. For this purpose the inventive solution for emergency opening of the movable surfaces can be used understandably also for fast closing of the same during occurrence of an accident event. For this purpose further propellent charges 21 must be arranged in a corresponding way to move the movable surfaces during ignition in a closing direction.

It will be understood that each of the elements described above, or two or more together, may also find a useful application in other types of methods and constructions differing from the types described above.

While the invention has been illustrated and described as embodied in method of emergency actuation of movable surfaces on vehicles, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of actuating surfaces which limit an inner space of a motor vehicle and are movable by adjusting drives, during occurrence of an accident event, the method comprising the steps of providing the vehicle with occupant protection systems, releasing the occupant protection systems by means of a bus system through a central control device; supplying to the central control device input signals of sensors which detect influences selected from the group consisting of outer influences, inner influences or both; and moving the surfaces which limit the inner space by the central control device through the bus system in dependence on an accident event, to their opening position.

2. A method as defined in claim 1; and further comprising determining in the control device in an evaluation routine gravity and category of the accident event based on the signals of the sensors; and activating releasing features of the occupant protection systems and/or opening of the surfaces which limit the inner space, depending on the determination of the gravity and category.

3. A method as defined in claim 2; and further comprising determining at least one parameter selected from the group consisting of a vehicle weight, retardation data, rotary speeds, distances to obstacles, a water level in the inner space, and combinations thereof.

4. A method as defined in claim 2; and further comprising determining a water level in the inner space of the vehicle by an element selected from the group consisting of a sensor with a float in a lower region of the vehicle, a partially not-lacquered coated printed circuit board inside the control device, and both.

5. A method as defined in claim 1; and further comprising arranging one of the sensors in the inner space of the vehicle.

6. A method as defined in claim 1; and further comprising controlling by the control device adjusting drives which drive the movable surfaces in an opening direction.

7. A method as defined in claim 1; and further comprising releasing by the control device gas generators of a first occupant protection system depending on a determined gravity and category of the accident event.

8. A method as defined in claim 1; and further comprising releasing by the control device propellent charges of a second occupant protection system.

9. A method as defined in claim 1; and further comprising providing one of the occupant protection systems with safety belts having belt locks; and automatically opening the belt locks in dependence on signals from the sensors.

10. A method as defined in claim 1; and further comprising performing actions after a detection of an accident event with a predetermined time delay, which actions are selected from the group consisting of a release of the occupant protection systems, an opening of the surfaces limiting the inner space, an opening of belt locks, and a combination thereof.

11. A method as defined in claim 1; and further comprising releasing by the control device propellent charges for opening the surfaces which limit the inner space of the vehicle.

12. A method as defined in claim 1; and further comprising releasing by the control device propellent charges for separation of adjusting drives from the surfaces which limit the inner space of the vehicle.

13. A method as defined in claim 1; and further comprising activating by the control device propellent charges inside doors of the vehicles; and separating by the propellent charges components of drive train of an adjusting drives of the same.

14. A method as defined in claim 1; and further comprising releasing by the control device propellent charges for releasing belt locks of safety belts.

15. A method as defined in claim 1; and further comprising supplying adjusting drives which limit the inner space through an electrical system of a vehicle; and also supplying the adjusting drives from a further power source for increasing a redundance.

16. A method as defined in claim 1; and further comprising using as a propellent charge in the inner space and on doors of the vehicles with a chemical substance which releases a controllable gas quantity.

17. A method of actuating surfaces which limit an inner space of the vehicle, which surfaces are actuated by adjusting drives having control devices, the method comprising the steps of supplying the control devices with input signals from sensors which detect influences selected from the group consisting of outer influences, inner influences and both; detecting by the sensors an occurrence of an accident event; and depending on an accident event moving through the control devices the surfaces which limit the inner space to their opening position.

18. A method as defined in claim 17; and further comprising determining in the control device in an evaluation routine gravity and category of the accident event based on the signals of the sensors; and activating releasing features of the occupant protection systems and/or opening of the surfaces which limit the inner space, depending on the determination of the gravity and category.

19. A method as defined in claim 18; and further comprising determining at least one parameter selected from the group consisting of a vehicle weight, retardation data, rotary speeds, distances to obstacles, a water level in the inner space, and combinations thereof.

20. A method as defined in claim 18; and further comprising determining a water level in the inner space of the vehicle by an element selected from the group consisting of a sensor with a float in a lower region of the vehicle, a partially not-lacquered coated printed circuit board inside the control device, and both.

21. A method as defined in claim 17; and further comprising arranging one of the sensors in the inner space of the vehicle.

22. A method as defined in claim 17; and further comprising controlling by the control device adjusting drives which drive the movable surfaces in an opening direction.

23. A method as defined in claim 17; and further comprising releasing by the control device gas generators of a first occupant protection system depending on a determined gravity and category of the accident event.

24. A method as defined in claim 17; and further comprising releasing by the control device propellent charges of a second occupant protection system.

25. A method as defined in claim 17; and further comprising providing one of the occupant protection systems with safety belts having belt locks; and automatically opening the belt locks in dependence on signals from the sensors.

26. A method as defined in claim 17; and further comprising performing actions after a detection of an accident event with a predetermined time delay, which actions are selected from the group consisting of a release of the occupant protection systems, an opening of the surfaces limiting the inner space, an opening of belt locks, and a combination thereof.

27. A method as defined in claim 17; and further comprising releasing by the control device propellent charges for opening the surfaces which limit the inner space of the vehicle.

28. A method as defined in claim 17; and further comprising releasing by the control device propellent charges for separation of adjusting drives from the surfaces which limit the inner space of the vehicle.

29. A method as defined in claim 17; and further comprising activating by the control device propellent charges inside doors of the vehicles; and separating by the propellent charges components of drive train of an adjusting drives of the same.

30. A method as defined in claim 17; and further comprising releasing by the control device propellent charges for releasing belt locks of safety belts.

31. A method as defined in claim 17; and further comprising supplying adjusting drives which limit the inner space through an electrical system of a vehicle; and also supplying the adjusting drives from a further power source for increasing a redundance.

32. A method as defined in claim 16; and further comprising using as a propellent charge in the inner space and on doors of the vehicles with a chemical substance which releases a controllable gas quantity.
